(19) United States
(12) Patent Application Publication
(10) Pub. No.: US 2013/0042468 A1
(43) Pub. Date: Feb. 21, 2013

(54) DISASSEMBLING TOOL

(71) Applicant: BING-SHENG CHEN, (US)

(72) Inventor: BING-SHENG CHEN, (US)

(21) Appl. No.: 13/210,701

(22) Filed: Aug. 16, 2011

(51) Int. Cl. B23P 19/00

(52) U.S. Cl. 29/700

(57) ABSTRACT

The present invention provides a disassembling tool including a cylinder and a clamping assembly. The cylinder includes two ear members, two pivoting holes, a casing hole and an opening. The clamping assembly includes two pulling arms and a clamping arm. The two pulling arms have a linking relation with the clamping arm. The clamping arm has a teeth section, used for increasing a fixing ability of the clamping arm. After fixing the tie rod in the cylinder, the two pulling arms drive the clamping arm pivot with respect to the pivoting hole. When the clamping arm pivots, the teeth section of the clamping arm clamps the tie rod, forcing the tie rod to rotate and become loosened. Because the clamping arm can completely pivot over the casing hole, the disassembling tool can easily disassemble not only tie rods with various sizes, but tie rods with even smaller sizes.

### BACKGROUND OF THE INVENTION

1. Field of the Invention

The present invention relates to the field of a disassembling tool, and more particularly to a disassembling tool capable of disassembling tie rods with various sizes.

2. Description of the Prior Art

Conventional disassembling tools are disclosed in patents such as U.S. Pat. No. 7,278,340 and DE102007027046A1. The disassembling tools of the patents mentioned above are use a cylinder to be protruded by a tie rod. Thus, the tie rod would be fixed in the cylinder by a gear so that the gear could drive the tie rod to rotate. Then the tie rod would be loosened to reach a goal of disassembling. However, though these two disassembling tools can be adapted to be used for disassembling tie rods with various sizes, tie rods with even smaller sizes still could not be loosened. As a result, when users want to disassemble a tie rod with even smaller, the tie rod size is too small to be loosened by the disassembling tool. As such, the disassembling tool mentioned above is not a convenient tool for users.

On the other hand, as what is disclosed in the patent DE102007027046A1, apart from limitations on the tie rod sizes mentioned above, the teeth device is disposed in the pivot hole on a rounding wall of the cylinder. A disadvantage is that the wall thickness of the pivot hole is not thick enough. Therefore, the more the disassembling tool is used, the easier the wall of the pivot hole would be deformed.

Besides, although the gear can be used to disassembling the tie rod, the torque of the gear is not effort-saving enough for users to disassemble the tie rod easily. Thus, users have to use more force to rotate the gear so that the tie rod can be disassembled.

Note that the gear has a rounding teeth surface, but only a small part of the teeth surface connects to the tie rod during an operation. Thus, the rounding teeth surface the gear can not completely connects to the tie rod to bring out a completely fixing function. When the gear rotates, only certain teeth force the tie rod to rotate at a time. Thus, without all teeth connecting to the tie rod, the teeth of the gear would be wear and tear faster, and the teeth which are wear and tear can not stably fix the tie rod in the cylinder as well. As a result, the tie rod is easy to slip in the cylinder.

### SUMMARY OF THE INVENTION

The main object of the present invention is to provide a disassembling tool capable of overcome the inconvenience and disadvantages mentioned above.

To achieve the above, the present invention provides a disassembling tool which includes a cylinder and a clamping assembly. The cylinder comprises two ear members, two pivoting hole, an opening and a casing hole. The opening is located on a side wall of the cylinder, and the opening connects to the casing hole. The cylinder has a connecting side on the side wall, and the connecting side corresponds to the opening. The cylinder defining an axial direction, and the two ear members axially protrudes out of an outer surface of the connecting side of the cylinder, the two pivoting hole is located on the two ear member respectively. The clamping assembly includes a clamping arm, two pulling arm and a connecting member. The clamping arm has an arc portion and a toothed section. The arc portion enables the clamping arm to increase a contact area with a target so that the target could be firmly clamped in the casing hole. The toothed section enables the arc portion to increase a clamping ability during a disassembling operation. One end of the clamping arm can pivotally disposed with the pivoting hole, and another end of the clamping arm is disposed with the two pulling arms. The two pulling arms pivot with respect to the clamping arm so that the two pulling arms reach a linking relation with the clamping arm. The connecting member is disposed with the two pulling arms, and the connecting member can not rotate with respect to the two pulling arms. The arc section is located at the clamping arm, and the toothed section is located at the arc section.

As such, when disassembling a tie rod, the two pulling arms drive the clamping arm close to the tie rod so as to fix the tie rod in the casing hole.

After fixing the tie rod in the casing hole, users force the forcing tool to drive the two pulling arms, and then the two pulling arms drive the clamping pivot with respect to a axis of the pivoting hole. The pivoting hole is located at the two ear members respectively. So the pivoting hole is more durable without deforming easily. The toothed section clamps the tie rod with forcing the tie rod to rotate when the clamping arm pivots with the two pulling arms. As a result, the tie rod would be loosened.

Because the clamping arm can completely pivot over a cross section of the cylinder when pivoting with respect to the pivoting hole, the disassembling tool can be adapted to disassemble not only tie rods of various sizes, but tie rods of even smaller sizes.

Besides, the clamping arm is designed in arc shape, so a contacting area is increased for the arc section to contact with the tie rod when the clamping arm clamps the tie rod. And the toothed section is located at the arc section, so a contacting area of the toothed section is also increased to firmly contact with the tie rod so that the tie rod would fixed in the cylinder with rotating along the pivoting direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a preferred embodiment of the present invention;

FIG. 2 is a decomposition drawing a preferred embodiment of the present invention;

FIG. 3 is a schematic drawing from an upper side showing a preferred embodiment of the present invention;

FIG. 4 is a schematic drawing from an upper side showing an operating condition in accordance with a preferred embodiment of the present invention.

### DETAILED DESCRIPTION OF THE PREFERRED EMBODIMENTS

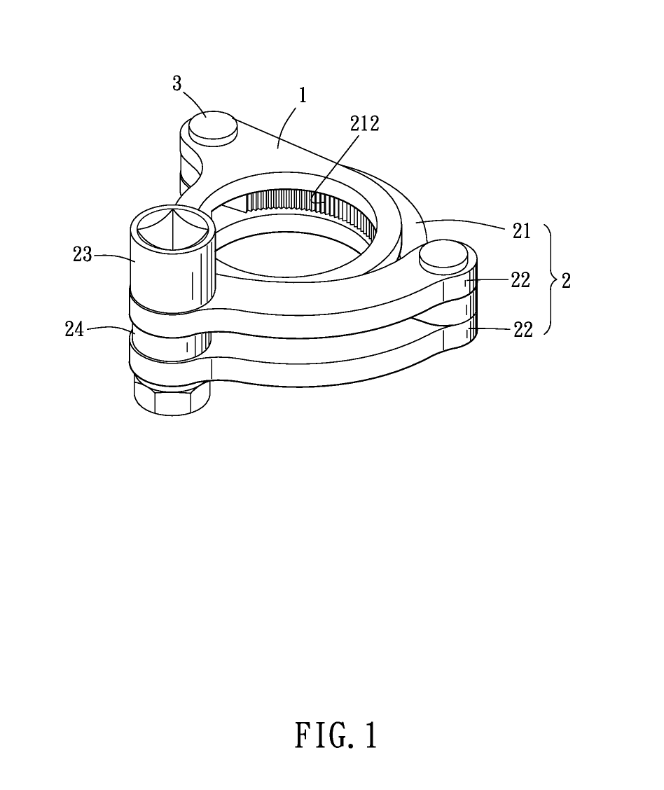

Please refer to FIG. 1 to FIG. 4. The disassembling tool of the present invention includes a cylinder 1 and a clamping assembly 2.

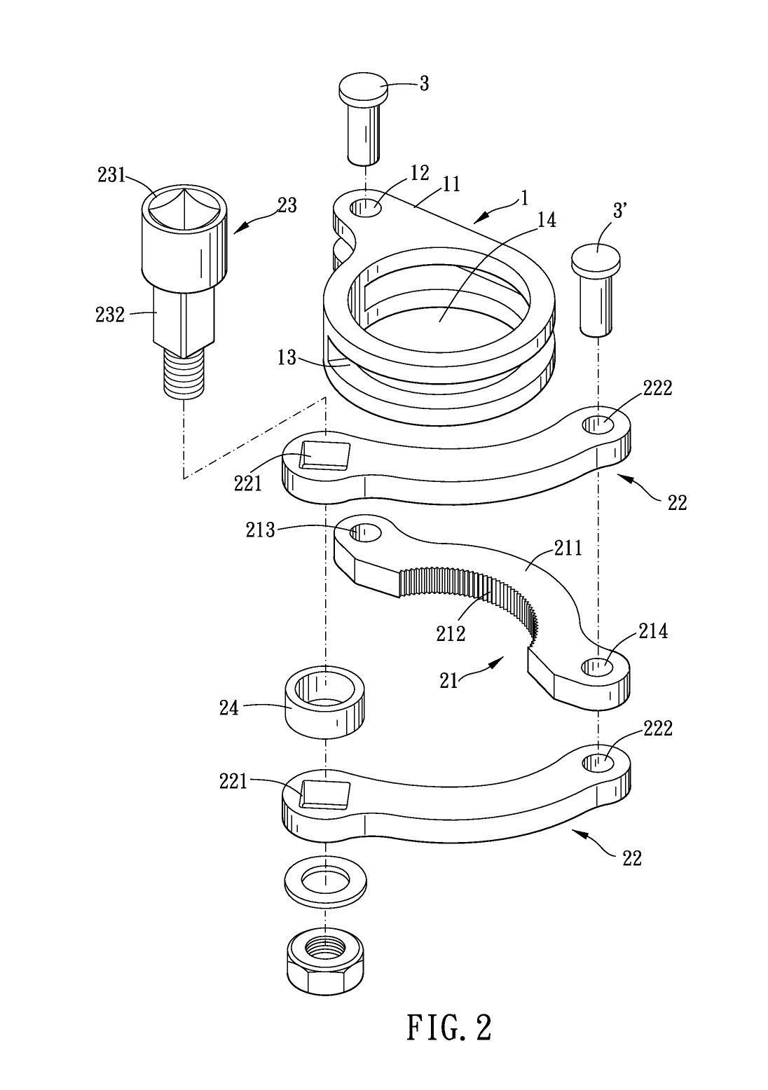

As shown in FIG. 1 and FIG. 2, the cylinder 1 comprises two ear members 11, two pivoting hole 12, an opening 13 and a casing hole 14. The opening 13 is located on a side wall of the cylinder 1, and the opening 13 connects to the casing hole 14. The cylinder 1 has a connecting side on the side wall, and the connecting side corresponds to the opening 13. The cylinder 1 defining an axial direction, and the two ear members 11 axially protrudes out of an outer surface of the connecting side of the cylinder 1, the two pivoting hole 12 is located on the two ear member 11 respectively. The two pivoting hole 12 are parallel to the casing hole 14. In a preferred embodiment of the present invention, the cylinder 1 can also comprise only the casing hole 14 with excluding the opening 13.

Please refer to FIG. 1 and FIG. 2 again, the clamping assembly 2 includes a clamping arm 21, two pulling arm 22 and a connecting member 23. The clamping arm 21 has an arc portion 211 and a toothed section 212. The arc portion 211 enables the clamping arm 21 to increase a contact area with a target so that the target could be firmly clamped in the cylinder 1. The toothed section 212 enables the arc portion 211 to increase a clamping ability during a disassembling operation. One end of the clamping arm 21 can pivotally disposed with the pivoting hole 12, and another end of the clamping arm 21 is disposed with the two pulling arms 22. The two pulling arms 22 pivot with respect to the clamping arm 21 so that the clamping arm 21 can pivot with respect to the pivoting hole 12 with pivoting over the cross section of the casing hole 14. The clamping arm 21 can pivot to the opening 13 inwardly and outwardly. So the clamping arm 21 would correctly follow a pivoting direction when the clamping arm 21 pivots with respect to the pivoting hole 12. The two pulling arms 22 are in arc shape so that torques of the two pulling arms 22 can be increased, and the disassembling operation would cost less effort to finish. Each of the two pulling arms 22 has a polygonal hole 221 on one end and a penetrating hole 222 on another end. Thus, assemblies disposed in the polygonal hole 221 could not pivot with respect to the two pulling arms 22, and forcing actions would make assemblies drive the two pulling arms 22 during the disassembling operation. The connecting member 23 includes a head portion 231 and bottom portion 232. The head portion 231 has a polygonal groove extending axially, and the bottom portion 232 has a wedging member and a threaded section. The wedging member is disposed in the polygonal holes 221 of the two pulling arms 22, and the threaded section screws with a screw nut. Therefore, the connecting member 23 can not rotate with respect to the two pulling arms 22. In a preferred embodiment of the present invention, there is a casing fulcrum 24 positioned between the two polygonal holes 221 of the two pulling arms 22, so a fixed distance is formed between the two pulling arms 22 so that the two pulling arms 22 would not be crooked during the disassembling operation. The clamping arm 21 has the arc section 211, and the toothed section 212 is located at the arc section 211. Both ends of the clamping arm 21 have a connecting hole 213 and an axial hole 214. The connecting hole 213 corresponds to the two pivoting holes 12 with being located between the two pivoting holes 12, and a bolt 3′ is disposed in the connecting hole 213 and the two pivoting holes 12. The axial hole 214 corresponds to the two penetrating holes 222 with being located between the two penetrating holes 222, and a bolt 3′ is also disposed in the axial hole 214 and the two penetrating holes 222. Thus, the two pulling arms 22 and the clamping arm 21 are linked with each other so that the two pulling arms 22 drive the clamping arm 21 pivot. In a preferred embodiment of the present invention, the clamping assembly 2 can also comprise only one pulling arm 2, and one end of the pulling arm 22 is disposed with the clamping arm 21 to reach a linking relation.

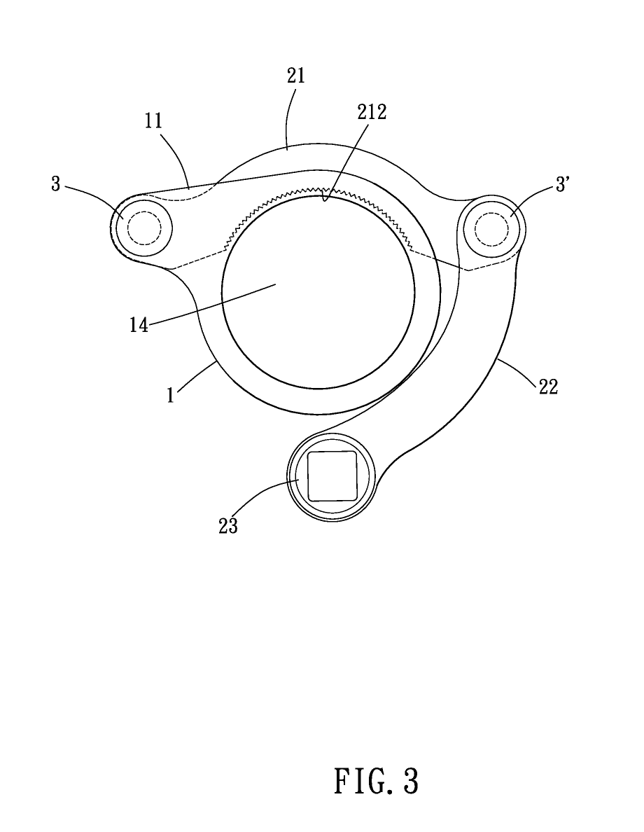

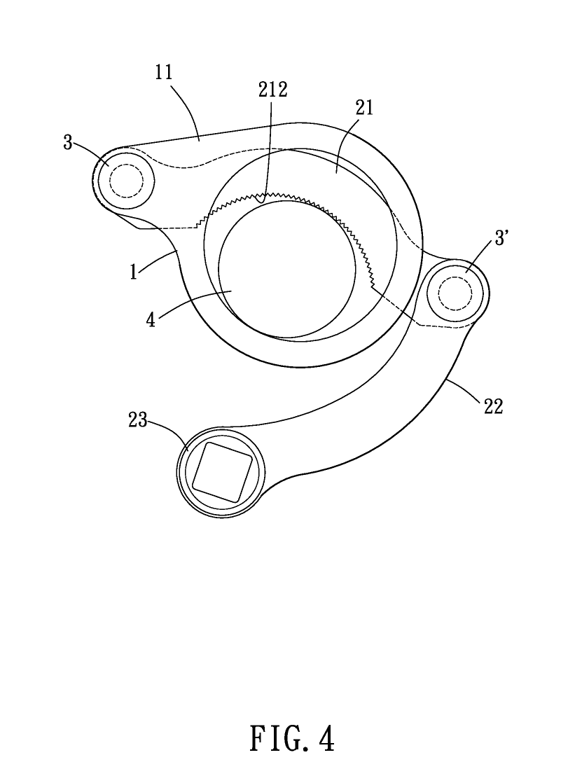

As what is mentioned above, the main object of the present invention is to provide a disassembling tool for disassembling tie rods. That is, please refer to FIG. 3 and FIG. 4, the tie rod 4 is positioned through the casing hole 14 with a forcing tool being disposed with the connecting member 23 of the pulling arms 22 when disassembling a tie rod 4. With the forcing tool, the two pulling arms 22 drive the clamping arm 21 close to the tie rod 4 so that the arc section 211 and the toothed section 212, and the tie rod 4 is fixed in the casing hole 14.

After fixing the tie rod 4 in the casing hole 14, users force the forcing tool to drive the two pulling arms 22, and then the two pulling arms 22 drive the clamping arm 21 pivoting with respect to an axis of the pivoting hole 12. The toothed section 212 clamps the tie rod 4 with forcing the tie rod 4 to rotate when the clamping arm 21 pivots with the two pulling arms 22. As a result, the tie rod 4 would be loosened, and the disassembling operation is finished.

For reasons that the disassembling tool of the present invention uses the clamping arm 21 to loosen the tie rod 4, and a length of the clamping arm 21 is greater than an internal diameter of the cylinder 1. Thus, the clamping arm 21 can completely pivot over a cross section of the cylinder 1 when pivoting with respect to the pivoting hole 12. Moreover, instead of being located at a side wall of the cylinder 1, the pivoting hole 12 is located at the two ear members 11 respectively. So the pivoting hole 12 is more durable without deforming easily. As such, the disassembling tool can be adapted to disassemble not only tie rods of various sizes, but tie rods of even smaller sizes.

Moreover, the clamping arm 21 is designed in arc shape, so a contacting area is increased for the arc section 211 to contact with the tie rod 4 when the clamping arm 21 clamps the tie rod 4. And the toothed section 212 is located at the arc section 211, so a contacting area of the toothed section 212 is also increased to firmly contact with the tie rod 4 so that the tie rod 4 would fixed in the cylinder 1 with rotating along the pivoting direction. Thus, teeth of the toothed section 212 are more durable as well. The lifetime of the present invention is longer, and users can operate the disassembling operation more conveniently.

On the other hand, note that the disassembling tool of the present invention uses the mechanics theorem. That is, the two pulling arms 22 and the clamping arm 21 serve as forcing arms. Thus, the torque of the forcing arms is increased. Users can use less strength to finish the disassembling operation.

What is claimed is:

1. A disassembling tool, comprising:
a cylinder, the cylinder defining an axial direction, the cylinder having a casing hole and a pivoting hole, the pivoting hole axially extending from a side wall of the cylinder; and
a clamping assembly, comprising at least a pulling arm and at least a clamping arm, the clamping arm having a toothed section, one end of the clamping arm being pivotally disposed with the pivoting hole, another end of the clamping arm being disposed with the pulling arm, the pulling arm can pivot with respect to the clamping arm.

2. The disassembling tool of claim 1, wherein the cylinder has an opening on the side wall, the clamping arm can pivot in the opening.

3. The disassembling tool of claim 1, wherein the clamping assembly comprises two pulling arms.

4. The disassembling tool of claim 2, wherein the cylinder has a connecting side on the side wall, the connecting side corresponds to the opening, at least one ear member protrudes from an outer surface of the connecting side, the pivoting hole is located on the ear member.

5. The disassembling tool of claim 1, wherein the pulling arm is in an arc shape, the pulling arm has a polygonal hole and a penetrating hole, the polygonal hole is located on one end of the pulling arm, the penetrating hole is located on another end of the pulling arm.

6. The disassembling tool of claim 4, wherein the clamping arm has an arc section, a connecting hole, and an axial hole, the toothed section is located on the arc section, the connecting hole corresponds to the pivoting hole, the axial hole corresponds to the penetrating hole, a length of the clamping arm is greater than a internal diameter of the cylinder.

7. The disassembling tool of claim 1, wherein the pulling arm comprises a connecting member, the connecting member comprises a head, a tail, a polygonal groove, and a lump, the polygonal groove is axially located on the head, the lump is located in the tail, one end of the pulling arm is disposed with the clamping arm, another end of the pulling arm is disposed with the connecting member, the connecting member can not pivot with respect to the pulling arm.

8. The disassembling tool of claim 2, wherein the pulling arm comprises a connecting member, the connecting member comprises a head, a tail, a polygonal groove and a lump, the polygonal groove is axially located on the head, the lump is located in the tail, one end of the pulling arm is disposed with the clamping arm, another end of the pulling arm is disposed with the connecting member, the connecting member can not pivot with respect to the pulling arm.

9. The disassembling tool of claim 3, wherein the pulling arm comprises a connecting member, the connecting member comprises a head, a tail, a polygonal groove and a lump, the polygonal groove is axially located on the head, the lump is located in the tail, one end of the pulling arm is disposed with the clamping arm, another end of the pulling arm is disposed with the connecting member, the connecting member can not pivot with respect to the pulling arm.

10. The disassembling tool of claim 4, wherein the pulling arm comprises a connecting member, the connecting member comprises a head, a tail, a polygonal groove and a lump, the polygonal groove is axially located on the head, the lump is located in the tail, one end of the pulling arm is disposed with the clamping arm, another end of the pulling arm is disposed with the connecting member, the connecting member can not pivot with respect to the pulling arm.

11. The disassembling tool of claim 5, wherein the pulling arm comprises a connecting member, the connecting member comprises a head, a tail, a polygonal groove, a threaded section and a lump, the polygonal groove is axially located on the head, the screw thread section is located at an end of the tail, the lump is located between the head and the tail, the lump is engaged in the polygonal hole, the connecting member can not pivot with respect to the pulling arm.

12. The disassembling tool of claim 6, wherein the pulling arm comprises a connecting member, the connecting member comprises a head, a tail, a polygonal groove, a screw thread section and a lump, the polygonal groove is axially located on the head, the screw thread section is located at the end of the tail, the lump is located between the head and the tail, the lump is engaged in the polygonal hole, the connecting member can not pivot with respect to the pulling arm.
